(19) United States
(12) Patent Application Publication
(10) Pub. No.: US 2025/0105918 A1
(43) Pub. Date: Mar. 27, 2025

(54) PLUGGABLE OPTICAL CHANNEL MONITOR

(71) Applicant: Jabil Technology (Wuhan) Ltd., Wuhan City (CN)

(72) Inventors: Ji Yu Peng, Wuhan (CN); Greg May, Kanata (CA); Giorgio Cazzaniga, Marcianise (IT)

(73) Assignee: Jabil Technology (Wuhan) Ltd., Wuhan City (CN)

(21) Appl. No.: 18/804,973

(22) Filed: Aug. 14, 2024

(30) Foreign Application Priority Data
Sep. 22, 2023 (CN) 202322596909.5

(51) Int. Cl. H04B 10/077; G02B 6/12

(52) U.S. Cl. CPC H04B 10/0779; G02B 6/12004; G02B 2006/12061

(57) ABSTRACT

A pluggable optical channel monitor is adapted to be plugged into a control system, and includes an outer casing, an optical signal transmission device, an optical signal monitoring device, and a push-pull device. The optical signal transmission device is disposed in the outer casing and is adapted for receiving an optical signal. The optical signal monitoring device is disposed in the outer casing and is connected to the optical signal transmission device for monitoring the optical signal. The push-pull device is mounted to the outer casing, protrudes outwardly of the outer casing, is operable to push the outer casing such that the pluggable optical channel monitor is plugged into the control system, and is operable to pull the outer casing such that the pluggable optical channel monitor is unplugged from the control system.

### CROSS-REFERENCE TO RELATED APPLICATION

This application claims priority to Chinese Utility Model Patent Application No. 202322596909.5, filed on Sep. 22, 2023, the entire disclosure of which is incorporated by reference herein.

### FIELD

The disclosure relates to an optical channel monitor, and more particularly to a pluggable optical channel monitor.

### BACKGROUND

An optical channel monitor (OCM) is generally provided for monitoring performance of an optical channel, which includes monitored information such as power, frequency, a wavelength, and an optical signal noise ratio (OSNR) of a signal transmitted in the optical channel. The optical channel monitor provides the monitored information of the signal transmitted in the optical channel to a control system. In this way, the control system may optimize the optical channel according to the monitored information.

When a conventional optical channel monitor is disposed on a circuit board of a control system, the conventional optical channel monitor is usually concealed and is not exposed, and thus cannot be easily plugged or unplugged by a user. Consequently, it is cumbersome to mount and detach the conventional optical channel monitor to and from the control system, which adversely affects convenience for maintenance or repair of the conventional optical channel monitor.

In addition, components of the conventional optical channel monitor are relatively large and heavy, so the conventional optical channel monitor is relatively heavy in weight and occupies a relatively large space, which is unfavorable in miniaturization.

### SUMMARY

Therefore, an object of the disclosure is to provide a pluggable optical channel monitor that can alleviate at least one of the drawbacks of the prior art.

According to the disclosure, a pluggable optical channel monitor adapted to be plugged into a control system is provided. The pluggable optical channel monitor includes an outer casing, an optical signal transmission device, an optical signal monitoring device, and a push-pull device. The optical signal transmission device is disposed in the outer casing, and is adapted for receiving an optical signal. The optical signal monitoring device is disposed in the outer casing, is connected to the optical signal transmission device, and is adapted for monitoring the optical signal. The push-pull device is mounted to the outer casing, protrudes outwardly of the outer casing, is operable to push the outer casing such that a portion of the pluggable optical channel monitor is plugged into the control system, and is operable to pull the outer casing such that the portion of the pluggable optical channel monitor is unplugged from the control system.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary partly exploded perspective view of a first embodiment of a pluggable optical channel monitor according to the present disclosure and a control system.

FIG. 2 is partly exploded perspective view of the first embodiment, illustrating a relationship among an outer casing, an optical signal monitoring device, an optical signal transmission device, and a push-pull device of the first embodiment.

FIG. 3 is a partly exploded perspective view of the first embodiment seen from an angle different from FIG. 2.

FIG. 4 is a fragmentary sectional view taken along line IV-IV in FIG. 1.

FIG. 5 is a sectional view taken along line V-V in FIG. 1.

FIG. 6 is a fragmentary schematic bottom view of the first embodiment.

FIG. 7 is a block diagram of the first embodiment.

FIG. 8 is a fragmentary sectional view of the first embodiment.

FIG. 9 is a fragmentary cross-sectional view of the first embodiment and a portion of the control system, illustrating that the first embodiment is plugged into the control system.

FIG. 10 is a view similar to FIG. 9, but illustrates that the first embodiment is unplugged from the control system.

FIG. 11 is a fragmentary sectional view similar to FIG. 8, but illustrates that a resilient member of the first embodiment is compressed.

FIG. 12 is a partly exploded perspective view of a second embodiment of the pluggable optical channel monitor according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

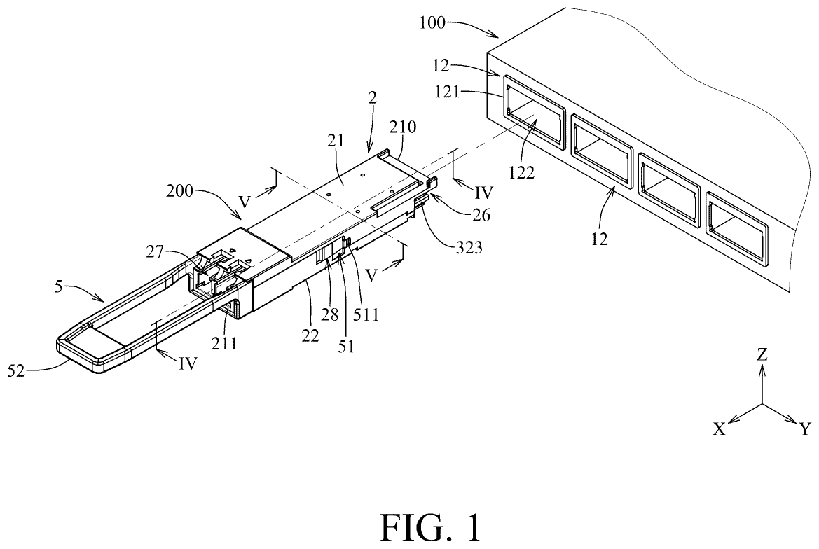

Referring to FIG. 1, a first embodiment of a pluggable optical channel monitor 200 according to the present disclosure is adapted to be plugged into a control system 100. The control system 100 is, for example, a switch, and the present disclosure is not limited thereto.

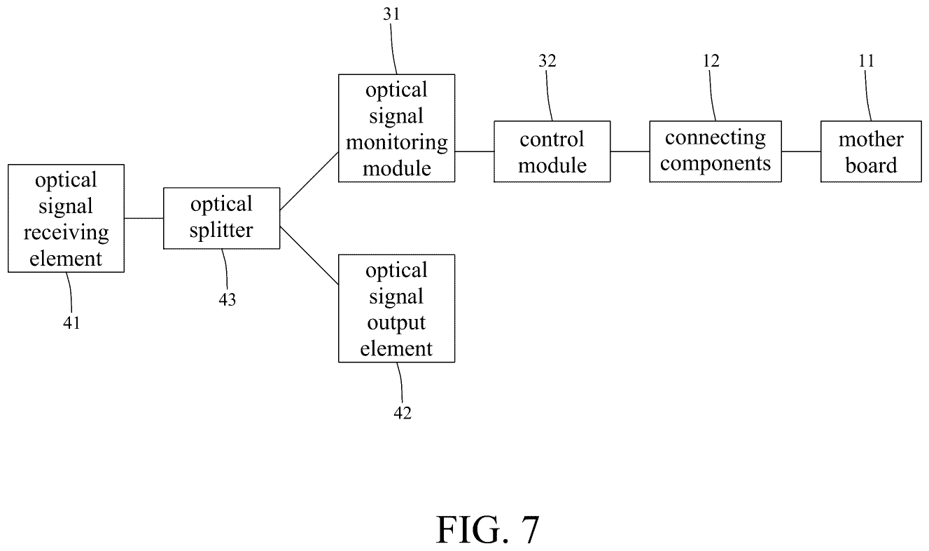

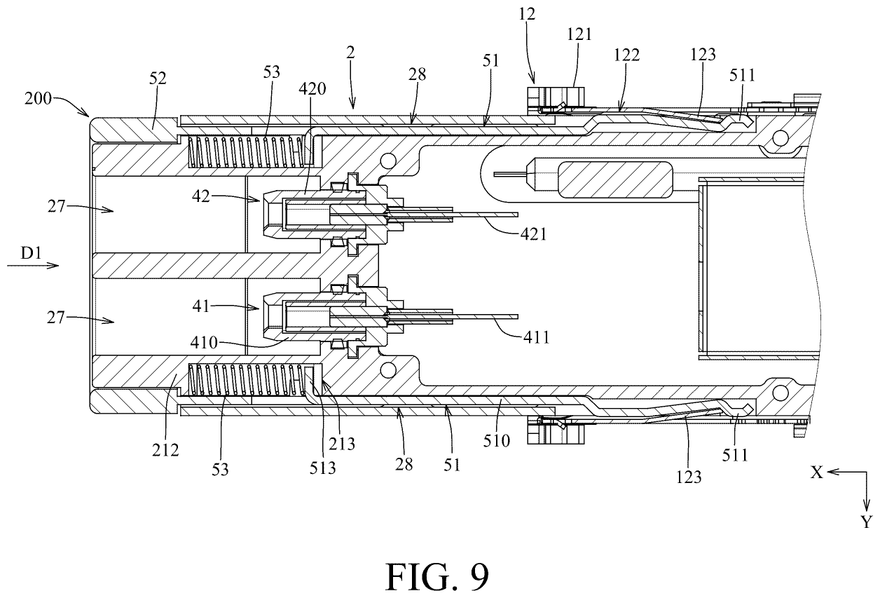

The control system 100 includes a mother board 11 (see FIG. 7), and a plurality of connecting components 12 connected to the mother board 11 and spaced apart from each other in a left-right direction (Y). Each of the connecting components 12 includes a socket connector (not shown) disposed on the mother board 11, and a shielding cover 121 disposed on the mother board 11 and covering the socket connector. The shielding cover 121 is formed with an insertion slot 122 for the pluggable optical channel monitor 200 to be plugged thereinto and unplugged therefrom. The shielding cover 121 has two resilient sheets 123 (see FIG. 9) spaced apart from each other in the left-right direction (Y).

The pluggable optical channel monitor 200 has an interface complementary in shape with the insertion slot 122 of each of the connecting components 12 so as to be plugged into the insertion slot 122 of a selected one of the connecting components 12 of the control system 100. In the first embodiment, the interface of the pluggable optical channel monitor 200 has the same specifications as, for example, a quad small form-factor pluggable (QSFP) interface, but is not limited thereto. It should be noted that the specifications of the interface of the pluggable optical channel monitor 200 may be other specifications of pluggable optical interfaces in different forms, such as a quad small form-factor pluggable double density (QSFP-DD) interface, a QSFP28 interface, a microQSFP interface, an optical small form-factor pluggable (OSFP) interface, a small form-factor pluggable (SFP) interface, a 10 gigabit small form-factor pluggable (XFP) interface, a 100G form-factor pluggable (CFP) interface, a CoaXPress (CXP) interface, etc., as required.

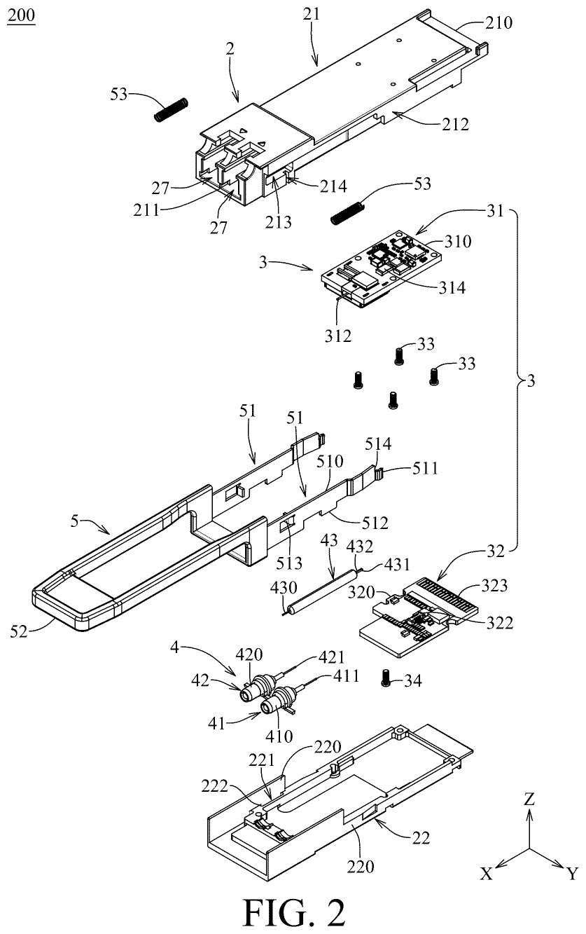

Referring further to FIGS. 2 to 4, the pluggable optical channel monitor 200 includes an outer casing 2, an optical signal monitoring device 3, an optical signal transmission device 4, and a push-pull device 5. The outer casing 2 is an elongated casing and is elongated in a front-rear direction (X) perpendicular to the left-right direction (Y). The outer casing 2 includes a casing body 21 and a cover body 22. The casing body 21 has an inserting end 210, a docking end 211, and two casing sidewalls 212. The outer casing 2 is inserted into the selected one of the insertion slots 122 through the inserting end 210. The docking end 211 is opposite to the inserting end 210 in the front-rear direction (X), faces forwardly, and is adjacent to the optical signal transmission device 4. The casing sidewalls 212 are spaced apart from each other in the left-right direction (Y). Each of the casing sidewalls 212 is formed with a receiving groove 213 that is adjacent to the docking end 211, and that extends in the front-rear direction (X), and a communication groove 214 that is in spatial communication with a bottom portion of the receiving groove 213 and that extends in an up-down direction (Z) perpendicular to the left-right direction (Y) and the front-rear direction (X). The cover body 22 is disposed under and covers a bottom side of the casing body 21, and is connected fixedly to the casing body 21 through a plurality of fastening members (not shown). The cover body 22 has two cover sidewalls 220 spaced apart from each other in the left-right direction (Y) and respectively connected to the casing sidewalls 212. Each of the cover sidewalls 220 is formed with a limiting groove 221 extending in the front-rear direction (X), and has a stop end surface 222 disposed at a front end of the limiting groove 221.

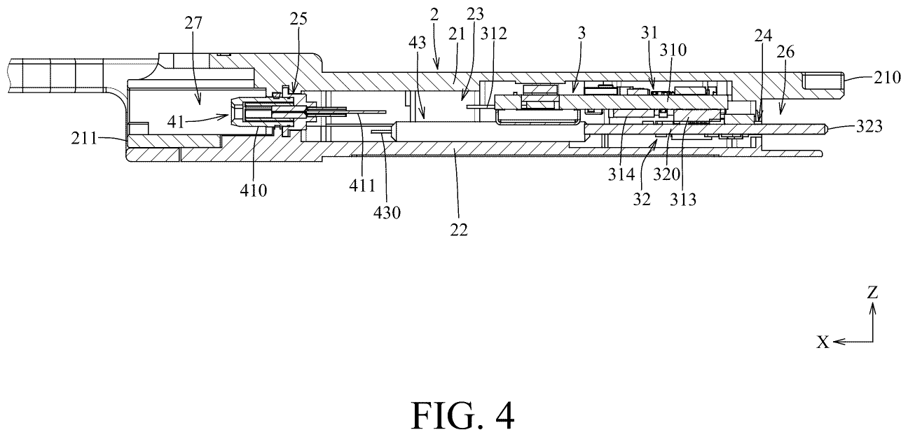

As shown in FIG. 4, the casing body 21 and the cover body 22 cooperatively define a receiving space 23, an opening 24 that is in spatial communication with a rear portion of the receiving space 23, two mounting holes 25 (only one is visible in FIG. 4) that are in spatial communication with a front portion of the receiving space 23 and that are spaced apart from each other in the left-right direction (Y), an accommodating groove 26 that is formed at the inserting end 210, that extends toward the docking end 211, and that is in spatial communication with the opening 24, two receiving slots 27 (only one is visible in FIG. 4) that are formed at the docking end 211, that extend toward the inserting end 210, and that are spaced apart from the mounting holes 25 in the front-rear direction (X), and two side guiding grooves 28 (only one is visible in FIG. 1) that are spaced apart from each other in the left-right direction (Y), and that are disposed respectively on left and right sides of the receiving space 23. The accommodating groove 26 is adapted to receive the socket connector of the selected one of the connecting components 12 of the control system 100. Each of the receiving slots 27 is adapted to be connected to an optical fiber connecting device (not shown). Each of the side guiding grooves 28 is defined between one of the casing sidewalls 212 and the respective one of the cover sidewalls 220 that are connected to each other. Each of the side guiding grooves 28 is in spatial communication with the receiving groove 213 and the communication groove 214 of a respective one of the casing sidewalls 212, and the limiting groove 221 of a respective one of the cover sidewalls 220.

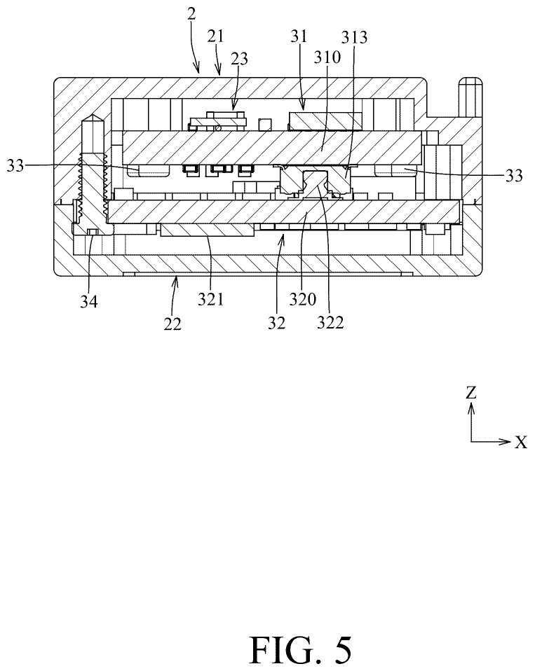

Referring to FIGS. 2 to 5, the optical signal monitoring device 3 is disposed in the receiving space 23 of the outer casing 2, and includes an optical signal monitoring module 31 and a control module 32. In this embodiment, the optical signal monitoring module 31 is a photonic integrated circuit (PIC) based on silicon photonic technology. Thus, high integration and miniaturization in volume of the optical signal monitoring device 3 may be achieved. The optical signal monitoring module 31 is mounted to the optical signal transmission device 4, and has a circuit board 310, a microcontroller (MC) 311, an optical fiber 312, a first connector 313, and a photonics device 314. The circuit board 310 is fixedly connected to the casing body 21 of the outer casing 2 by a plurality of fastening members 33. The microcontroller 311 is disposed on a bottom surface of the circuit board 310 in this embodiment. The optical fiber 312 is optically attached to the photonics device 314 and is adapted for receiving an optical signal. The first connector 313 is disposed on the bottom surface of the circuit board 310. The photonics device 314 is integrated to the circuit board 310 and has two portions respectively exposed on the bottom surface and a top surface of the circuit board 310. The photonics device 314 may include an optic component and an optoelectronics component respectively having different functions. The optical signal monitoring module 31 is adapted to obtain monitored information from the optical signal received by the optical fiber 312. Specifically, the microcontroller 311 cooperates with the photonics device 314 to obtain the monitored information from the optical signal.

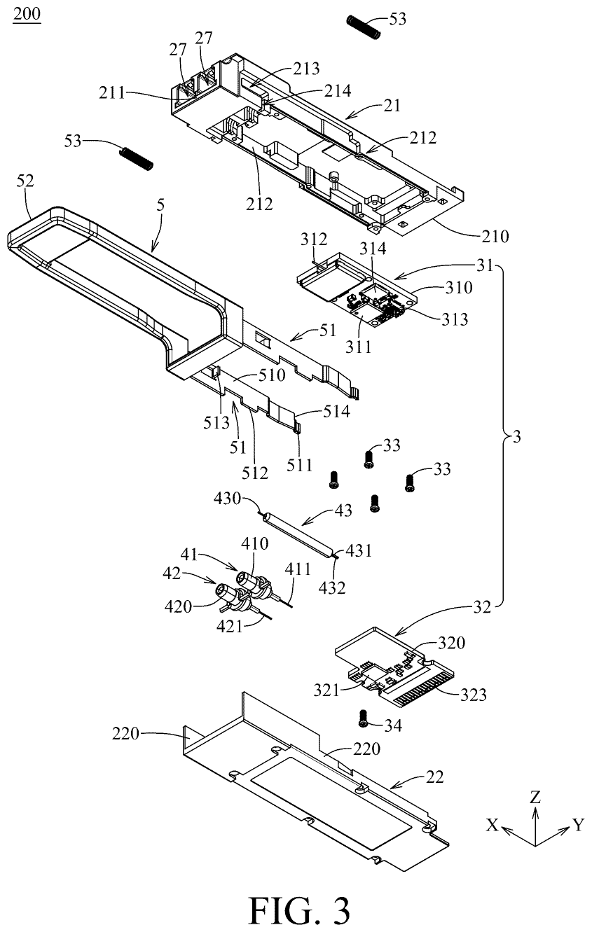

The control module 32 is mounted to the optical signal transmission device 4 and includes a circuit board 320, a microcontroller 321, and a second connector 322 (see FIGS. 2 and 3). The circuit board 320 is mounted under the circuit board 310 of the optical signal monitoring module 31 and is fixedly fastened to the casing body 21 of the outer casing 2 through a fastening member 34. The circuit board 320 is disposed in the receiving space 23, extends through the opening 24, and has an inserting portion 323 (see FIG. 2) extending outwardly of the opening 24 into in the accommodating groove 26. The inserting portion 323 is adapted to be inserted into the socket connector of the selected one of the connecting components 12 (see FIG. 1). The microcontroller 321 is disposed on a bottom surface of the circuit board 320 in this embodiment. The second connector 322 is disposed on a top surface of the circuit board 320 and is electrically connected to the first connector 313 of the optical signal monitoring module 31. Thus, the control module 32 is electrically connected to the optical signal monitoring module 31 for transmitting information.

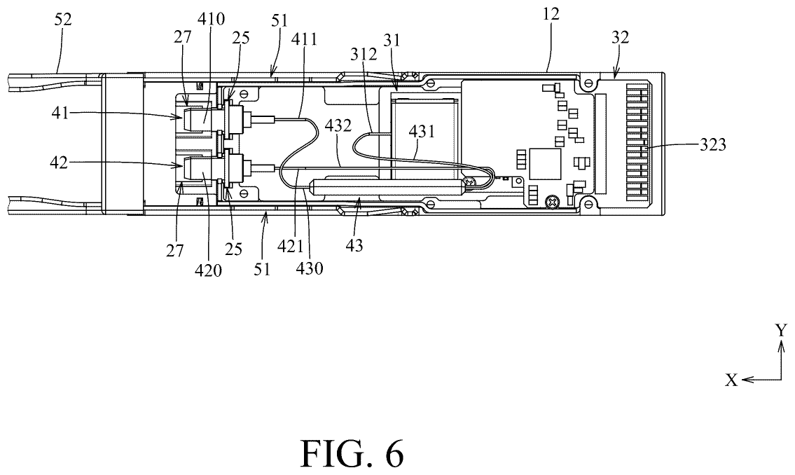

Referring to FIGS. 2, 3, 4, 6 and 7, the optical signal transmission device 4 includes an optical signal receiving element 41, an optical signal output element 42, and an optical splitter 43. The optical signal receiving element 41 includes an optical fiber connector 410 and an optical fiber 411. The optical fiber connector 410 is mounted to one of the mounting holes 25 of the outer casing 2 and is disposed adjacent to the docking end 211. A portion of the optical fiber connector 410 is received in one of the receiving slots 27 and is adapted to be connected to an optical fiber connecting device (not shown). In this embodiment, the optical fiber connector 410 is exemplified by a lucent connector, ultra physical contact (LC/UPC) connector, but is not limited thereto. The optical fiber 411 of the optical signal receiving element 41 extends through the optical fiber connector 410 and extends outwardly of a rear end of the optical fiber connector 410. In this embodiment, the optical fiber 411 is adapted for receiving an optical signal from a main optical path such as an optical fiber that is connected to the optical fiber connecting device (not shown).

In this embodiment, the optical signal output element 42 and the optical signal receiving element 41 have the same structures. That is, the optical signal output element 42 includes an optical fiber connector 420 and an optical fiber 421. The optical fiber connector 420 is mounted to the other one of the mounting holes 25 of the outer casing 2 and is disposed adjacent to the docking end 211. A portion of the optical fiber connector 420 is received in the other one of the receiving slots 27 and is adapted to be connected to another optical fiber connecting device (not shown). In this embodiment, the optical fiber connector 420 is exemplified by an LC/UPC connector, but is not limited thereto. The optical fiber 421 extends through the optical fiber connector 420 and extends outwardly of a rear end of the optical fiber connector 420.

The optical splitter 43 is connected among the optical signal receiving element 41, the optical signal output element 42 and the optical signal monitoring device 3. In this embodiment, the optical splitter 43 is exemplified by a one-in two-out (1×2) optical splitter, and includes an input optical fiber 430, a first output optical fiber 431, and a second output optical fiber 432. The input optical fiber 430 has one end connected to the optical fiber 411 of the optical signal receiving element 41 and adapted for receiving the optical signal outputted by the optical fiber 411. The first output optical fiber 431 has two ends respectively connected to another end of the input optical fiber 430 and the optical fiber 312 of the optical signal monitoring module 31. The second output optical fiber 432 has two ends respectively connected to the another end of the input optical fiber 430 and the optical fiber 421 of the optical signal output element 42. The optical splitter 43 is adapted for splitting and outputting, in a predetermined splitting ratio, the optical signal received from the input optical fiber 430, to the optical signal monitoring module 31 of the optical signal monitoring device 3 via the first output optical fiber 431, and to the optical signal output element 42 via the second output optical fiber 432. In this way, the optical signal monitoring module 31 may obtain the monitored information from the optical signal received by the optical fiber 312 and monitor the same.

In the first embodiment, the optical splitter 43 is configured to split the optical signal received by the input optical fiber 430, to output 5% of the optical signal to the optical signal monitoring module 31 via the first output optical fiber 431, and to output 95% of the optical signal to the optical signal output element 42 via the second output optical fiber 432. In this way, a portion of the optical signal is received and monitored by the optical signal monitoring module 31, and the majority of the optical signal is transmitted to the main optical path via the optical signal output element 42 and the another optical fiber connecting device connected thereto. It should be noted that the predetermined splitting ratios of 5% and 95% may be modified according to actual requirements, and are not limited to the example described herein.

Referring to FIGS. 1, 5, 6 and 7, the optical signal monitoring module 31 is adapted to obtain, from the 5% of the optical signal received from the first output optical fiber 431, monitored information such as power, frequency, a wavelength, and an optical signal noise ratio (OSNR) of the 5% of the optical signal, and to transmit the monitored information to the control module 32. Thus, the control module 32 is adapted to transmit the monitored information to the selected one of the connecting components 12 of the control system 100 by the inserting portion 323, and then to transmit the same to the mother board 11 through the selected one of the connecting components 12. The control module 32 is adapted to receive, by the inserting portion 323, configuration information such as an alarm, a reset and a loss threshold that is outputted from the mother board 11 of the control system 100 to the selected one of the connecting components 12, and then the control module 32 is adapted to transmit the configuration information to the optical signal monitoring module 31.

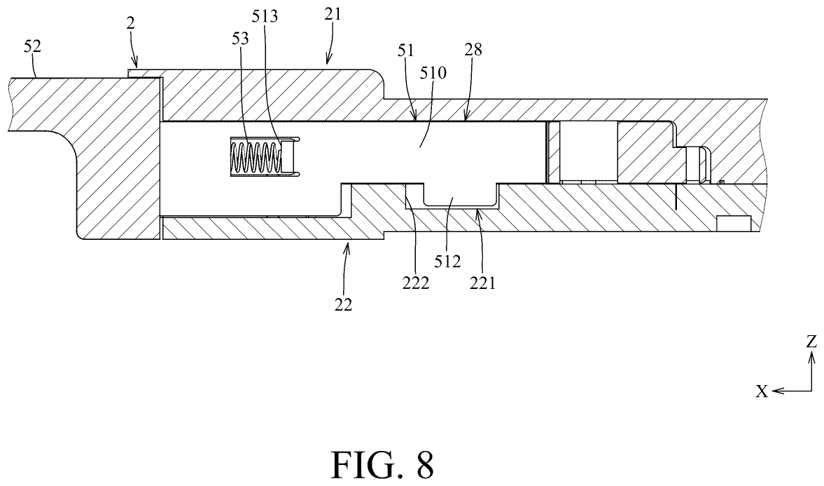

Referring to FIGS. 1, 2, 3 and 8, the push-pull device 5 is mounted to the outer casing 2 and has a portion extending outwardly of the docking end 211 of the outer casing 2. The push-pull device 5 is operable to push the outer casing 2 such that a portion of the pluggable optical channel monitor 200 is plugged into the control system 100, and is operable to pull the outer casing 2 such that the portion of the pluggable optical channel monitor 200 is unplugged from the control system 100. Specifically, the push-pull device 5 can be pushed and pulled such that the inserting portion 323 disposed in the outer casing 2 can be inserted into and removed from the insertion slot 122 of the selected one of the connecting components 12 of the control system 100. The push-pull device 5 includes two locking resilient plates 51, a push-pull handle 52, and two resilient members 53. The locking resilient plates 51 are slidably connected to the outer casing 2 and are adapted for locking the outer casing 2 to the selected one of the connecting components 12 of the control system 100. Each of the locking resilient plates 51 includes a sliding plate body 510, an engaging plate body 511, a protruding sheet body 512, and a bendable sheet body 513. For each of the locking resilient plates 51, the sliding plate body 510 is slidably connected to a respective one of the side guiding grooves 28, is elongated in the front-rear direction (X), and has a terminating end 514 facing rearwardly. For each of the locking resilient plates 51, the engaging plate body 511 extends from the terminating end 514 of the sliding plate body 510, is curved, and is adapted for engaging the control system 100. Specifically, the engaging plate body 511 of each of the locking resilient plates 51 is operable to engage a respective one of the resilient sheets 123 (see FIG. 9) of the shielding cover 121 of the selected one of the connecting components 12, thereby locking the locking resilient plate 51 to the selected one of the connecting components 12. For each of the locking resilient plates 51, the protruding sheet body 512 extends downwardly from a bottom side of the sliding plate body 510, is slidably received in the limiting groove 221 of a respective one of cover sidewalls 220, and is operable to abut against the stop end surface 222 to limit movement of the locking resilient plate 51 relative to the outer casing 2 when the push-pull handle 52 is pulled. For each of the locking resilient plates 51, the bendable sheet body 513 extends transversely from the sliding plate body 510, is bent inwardly, and extends through and is slidable along the receiving groove 213 of a respective one of the casing sidewalls 212. To assemble the push-pull device 5 to the outer casing 2, the bendable sheet body 513 of each of the locking resilient plates 51 extends into the receiving groove 213 of the respective one of the casing sidewalls 212 by first passing through the communication groove 214 of the respective one of the casing sidewalls 212.

The push-pull handle 52 is connected to a front end of the sliding plate body 510 of each of the locking resilient plates 51, extends outwardly of the docking end 211 of the outer casing 2, and is operable to be pushed and pulled in order to lock and release the locking resilient plates 51 to and from the selected one of the connecting components 12 of the control system 100, such that the outer casing 2 is locked to and released from the control system 100. In the first embodiment, the push-pull handle 52 is, e.g., connected fixedly to a front end of the sliding plate body 510 of each of the locking resilient plates 51, and the structure of the push-pull handle 52 is not limited hereto. In other implementation of the first embodiment, the push-pull handle 52 may be pivotably connected to the sliding plate body 510 of each of the locking resilient plates 51.

Referring to FIGS. 2, 3, and 9, each of the resilient members 53 is disposed in the receiving groove 213 of a respective one of the casing sidewalls 212 and between the outer casing 2 and the respective one of the locking resilient plates 51. Specifically, two ends of each of the resilient members 53 respectively abut against the respective one of the casing sidewalls 212 of the outer casing 2 and the bendable sheet body 513 of the respective one of the locking resilient plates 51. In this way, each of the resilient members 53 biases the respective one of the locking resilient plates 51 in a direction opposite to the push-pull handle 52, i.e., in a direction toward the inserting portion 323. By virtue of such structure, each of the locking resilient plates 51 is positioned at an initial position shown in FIG. 9.

Referring to FIGS. 1 and 9, in order to insert the pluggable optical channel monitor 200 into the insertion slot 122 of the selected one of the connecting components 12 of the control system 100, the inserting end 210 of the outer casing 2 is first aligned with the insertion slot 122 of the selected one of the connecting components 12 in the front-rear direction (X). Then, the push-pull handle 52 is pushed rearwardly in a pushing direction (D1) parallel to and opposite to the front-rear direction (X), so that the push-pull handle 52 drives the outer casing 2 to move rearwardly through connection among the locking resilient plates 51 and the outer casing 2. During rearward movement of the pluggable optical channel monitor 200 in the pushing direction (D1), the inserting end 210 and the inserting portion 323 first extend into the insertion slot 122 of the selected one of the connecting components 12, and the engaging plate bodies 511 of the locking resilient plates 51 are resiliently clamped between and are respectively in contact with the resilient sheets 123 of the shielding cover 121 of the selected one of the connecting components 12. As the push-pull handle 5 is continuously and rearwardly moved, the resilient sheets 123 are slightly deformed to move away from each other and thus store a restoring force, and then each of the engaging plate bodies 511 moves beyond a distal end of a respective one of the resilient sheets 123. When the pluggable optical channel monitor 200 is moved to a plug-in position shown in FIG. 9, the resilient sheets 123 are restored to their original positions by the restoring force stored thereby, so that the distal end of each of the resilient sheets 123 engages the respective one of the locking resilient plates 51 such that the locking resilient plates 51 are connected to the shielding cover 121 of the selected one of the connecting components 12. Accordingly, the pluggable optical channel monitor 200 may be stably located at the plug-in position.

Referring to FIGS. 4, 6, and 9, when the pluggable optical channel monitor 200 is at the plug-in position, the inserting portion 323 of the control module 32 is inserted into and is electrically connected to the socket connector (not shown) of the selected one of the connecting components 12, and the accommodating groove 26 of the outer casing 2 receives the socket connector (not shown) of the selected one of the connecting components 12 therein. In this way, the optical fiber connecting devices (not shown) are respectively inserted into the receiving slots 27, and are respectively connected to the optical fiber connector 410 of the optical signal receiving element 41 and the optical fiber connector 420 of the optical signal output element 42.

The optical fiber 411 of the optical signal receiving element 41 transmits, to the input optical fiber 430 of the optical splitter 43, the optical signal inputted by the optical fiber connecting device upon receipt of the same. The optical splitter 43 first splits the optical signal, and then outputs the portion of the optical signal by the first output optical fiber 431 to the optical signal monitoring module 31 for monitoring the same, and outputs the majority of the optical signal by the second output optical fiber 432 to the optical signal output element 42. In this way, the optical signal output element 42 receives and outputs the majority of the optical signal to the another optical fiber connecting device and thus to the main optical path. The microcontroller 311 of the optical signal monitoring module 31 obtains the monitored information from the portion of the optical signal received by the first output optical fiber 431 and outputs the same to the control module 32. Thus, the control module 32 outputs the monitored information to the selected one of the connecting components 12 of the control system 100 (as shown in FIG. 1) by the inserting portion 323 and then to the mother board 11 through the selected one of the connecting components 12. In this way, the control system 100 may use the monitored information uploaded to the mother board 11 as a basis for subsequent monitoring, adjustment, and analysis operations. When another configuration information for the optical signal monitoring module 31, e.g., which is modified according to the monitored information, is to be set by the control system 100, the control module 32 receives the another configuration information outputted by the mother board 11 of the control system 100 to the selected one of the connecting components 12 by the inserting portion 323, and then transmits the another configuration information to the optical signal monitoring module 31 so as to complete setting of the optical signal monitoring module 31 according to the another configuration information. Accordingly, the control system 100 may modify configuration information provided to the optical signal monitoring module 31 according to the monitored information obtained from the pluggable optical channel monitor 200 so as to optimize performance of the optical channel.

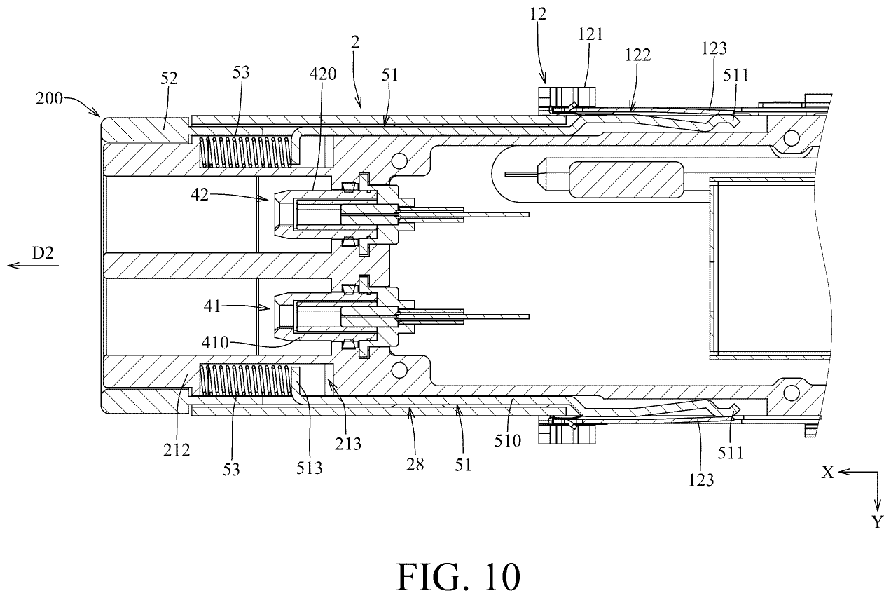

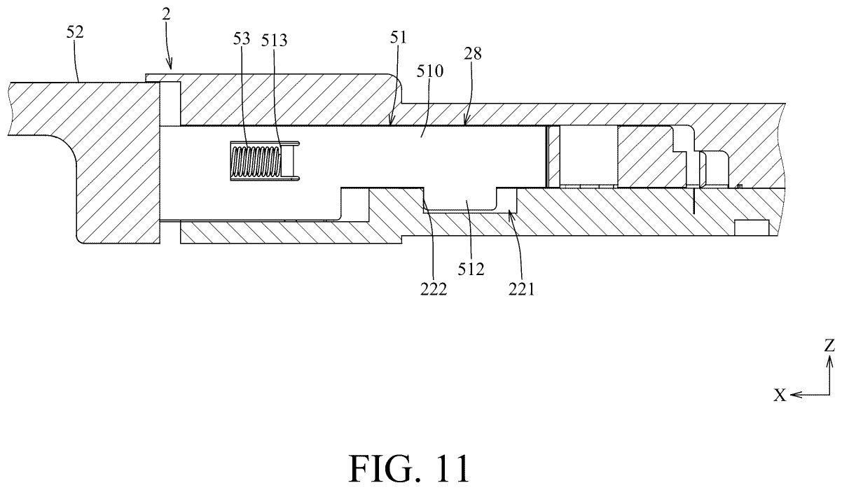

Referring to FIGS. 10 and 11, when it is desired to unplug the pluggable optical channel monitor 200 from the insertion slot 122 of the selected one of the connecting components 12, the push-pull handle 52 is pulled forwardly in a pulling direction (D2) opposite to the pushing direction (D1) and thus the push-pull handle 52 drives the sliding plate bodies 510 of the locking resilient plates 51 to slide forwardly relative to the outer casing 2. During sliding movement of the locking resilient plates 51 in the pulling direction (D2), the resilient sheets 123 are slightly deformed to move away from each other as being respectively pushed by the engaging plate bodies 511, the resilient members 53 are respectively compressed by the bendable sheet bodies 513 of the locking resilient plates 51, thereby storing a restoring force, and the protruding sheet bodies 512 of the locking resilient plates 51 respectively and forwardly slide along the limiting grooves 221 of the cover sidewalls 220. When the engaging plate bodies 511 respectively disengage from the distal ends of the resilient sheets 123, the locking resilient plates 51 unlock the outer casing 2 from the selected one of the connecting components 12.

When the push-pull handle 52 is continuously pulled forwardly in the pulling direction (D2), a pulling force exerted on the locking resilient plates 51 by the push-pull handle 52 is transmitted to the outer casing 2 sequentially through the bendable sheet body 513 and the resilient members 53 so as to drive the outer casing 2 to slide forwardly. The pulling force exerted by the push-pull handle 52 may be evenly transmitted to the outer casing 2 through the resilient members 53 and the protruding sheet bodies 512 of the locking resilient plates 51, such that the outer casing 2 may smoothly slide relative to the shielding cover 121 of the selected one of the connecting components 12. In this way, the inserting portion 323 (FIG. 4) may be smoothly removed from the socket connector of the selected one of the connecting components 12, and thus the pluggable optical channel monitor 200 may be smoothly removed from the insertion slot 122 of the selected one of the connecting components 12.

After the pluggable optical channel monitor 200 is unplugged from the insertion slot 122 of the selected one of the connecting components 12, the push-pull handle 52 is released, and the resilient members 53 respectively spring back the locking resilient plates 51 by the restoring force stored thereby, so that the locking resilient plates 51 are restored to the initial position (see FIG. 9).

Referring to FIGS. 1 and 4, the push-pull device 5 is accessible for a user to push and pull to thereby plug and unplug the pluggable optical channel monitor 200 into and from the insertion slot 122 of the selected one of the connecting components 12 of the control system 100. Accordingly, it is easy to unplug the pluggable optical channel monitor 200 and thus maintenance or repair of the pluggable optical channel monitor 200 is quite simple and convenient.

In addition, since the optical signal monitoring module 31 is a photonic integrated circuit based on silicon photonics technology, high integration and miniaturization in volume may be achieved. As such, the pluggable optical channel monitor 200 has a smaller volume and a lighter weight as compared to the conventional optical channel monitor and may achieve a design requirement of miniaturization. Furthermore, the pluggable optical channel monitor 200 is designed to be compatible with specifications of connectors of optical modules available on the market, so the pluggable optical channel monitor 200 may be applied in the same situation as the conventional optical channel monitor.

Since the optical signal monitoring module 31 and the control module 32 are separate components, more than one photonics devices 314 may be integrated on the optical signal monitoring module 31, and a number of electronic devices may be integrated on the control module 32. By doing so, the pluggable optical channel monitor 200 may monitor various types of monitored information as required. Moreover, the optical signal monitoring module 31 and the control module 32 are stacked together so a space that is occupied by the optical signal monitoring device 3 on a two-dimensional plane extending in the front-rear direction (X) and the left-right direction (Y) may be relatively small, so that an overall structure of the pluggable optical channel monitor 200 is relatively compact and occupies a relatively small space.

It should be noted that, the first embodiment of the pluggable optical channel monitor 200 may be modified as follows. In this modification, the optical signal output element 42 and the optical splitter 43 are omitted, and the another optical fiber connecting device to which the optical signal receiving element 41 of the optical signal transmission device 4 is connected is adapted to output a portion of the optical signal of the main optical path that is split by an external splitter. The optical fiber 411 of the optical signal receiving element 41 is directly connected to the optical fiber 312 of the optical signal monitoring module 31, so that the portion of the optical signal is directly transmitted from the optical signal receiving element 41 to the optical signal monitoring module 31 to thereby perform subsequent monitoring procedures.

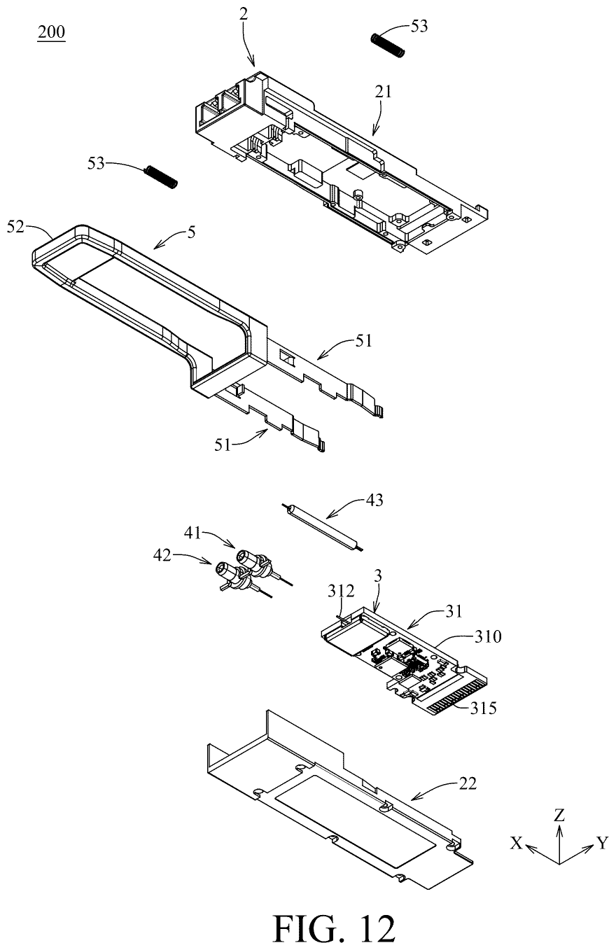

Referring to FIG. 12, a second embodiment of a pluggable optical channel monitor 200 according to the present disclosure is shown. The second embodiment is similar to the first embodiment, except that the optical signal monitoring device 3 of the second embodiment is modified.

In the second embodiment, the control module 32 is omitted and the optical signal monitoring module 31 possesses functions provided by the control module 32 of the first embodiment. Specifically, the circuit board 310 is disposed in the receiving space 23, extends through the opening 24, and has an inserting portion 315 (see FIG. 15) extending outwardly of the opening 24 into in the accommodating groove 26 and adapted to be inserted into the socket connector of the selected one of the connecting components 12 of the control system 100 (see FIG. 1). The optical signal monitoring module 31 is adapted to obtain the monitored information from a portion of the optical signal and the inserting portion 315 is adapted to output the same to the control system 100. Additionally, the optical signal monitoring module 31 is further adapted to receive the configuration information outputted from the mother board 11 of the control system 100 by the inserting portion 315. In this way, the manufacturing cost of the optical signal monitoring device 3 may be further reduced as compared to the first embodiment.

To sum up, in the pluggable optical channel monitor 200 of the present disclosure, the push-pull device 5 is provided for the user to push and pull so as to facilitate convenience of plugging and unplugging the pluggable optical channel monitor 200, so maintenance or repair of the pluggable optical channel monitor 200 is relatively simple and convenient. Furthermore, the optical signal monitoring module 31 is a photonic integrated circuit based on silicon photonics technology, thus high integration and miniaturization in volume may be achieved. In this way, the pluggable optical channel monitor 200 has a relatively small volume and a relatively light weight, and thus the design requirement of miniaturization may be achieved. In addition, the pluggable optical channel monitor 200 is designed to be compatible with specifications of connectors of optical modules available on the market and is useful to be applied thereto.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A pluggable optical channel monitor adapted to be plugged into a control system, said pluggable optical channel monitor comprising:
an outer casing;
an optical signal transmission device disposed in said outer casing and adapted for receiving an optical signal;
an optical signal monitoring device disposed in said outer casing, connected to said optical signal transmission device, and adapted for monitoring the optical signal; and
a push-pull device mounted to said outer casing, protruding outwardly of said outer casing, operable to push said outer casing such that a portion of said pluggable optical channel monitor is plugged into the control system, and operable to pull said outer casing such that said portion of said pluggable optical channel monitor is unplugged from the control system.

2. The pluggable optical channel monitor as claimed in claim 1, wherein said optical signal monitoring device includes an optical signal monitoring module connected to said optical signal transmission device, being a photonic integrated circuit that is based on silicon photonics technology, and having an inserting portion that is adapted to be inserted into the control system.

3. The pluggable optical channel monitor as claimed in claim 2, wherein:
said optical signal monitoring module is adapted to obtain monitored information from the optical signal;
said inserting portion is adapted to output the monitored information to the control system; and
said optical signal monitoring module is adapted to receive configuration information, which is outputted by the control system, by said inserting portion.

4. The pluggable optical channel monitor as claimed in claim 1, wherein:
said optical signal monitoring device includes
an optical signal monitoring module connected to said optical signal transmission device, and being a photonic integrated circuit based on silicon photonics technology,
a control module mounted to said optical signal transmission device, electrically connected to said optical signal monitoring module, and having an inserting portion adapted to be inserted into the control system.

5. The pluggable optical channel monitor as claimed in claim 4, wherein:
said optical signal monitoring module is adapted to obtain monitored information from the optical signal, and to transmit the monitored information to said control module; and
said control module is adapted to transmit the monitored information to the control system via said inserting portion, to receive configuration information, which is outputted by the control system, via said inserting portion, and then to transmit the configuration information to said optical signal monitoring module.

6. The pluggable optical channel monitor as claimed in claim 4, wherein:
said optical signal monitoring module has a first connector; and
said control module has a second connector electrically connected to said first connector.

7. The pluggable optical channel monitor as claimed in claim 1, wherein:
said optical signal transmission device includes
an optical signal receiving element adapted for receiving the optical signal,
an optical signal output element, and
an optical splitter connected among said optical signal receiving element, said optical signal output element, and said optical signal monitoring device, said optical splitter being adapted for splitting and outputting, in a predetermined splitting ratio, the optical signal to said optical signal monitoring device and said optical signal output element.

8. The pluggable optical channel monitor as claimed in claim 7, wherein:
said outer casing has an inserting end and a docking end opposite to said inserting end;
said outer casing is formed with two receiving slots formed at said docking end and extending toward said inserting end; and
a portion of said optical signal receiving element and a portion of said optical signal output element are respectively received in said receiving slots.

9. The pluggable optical channel monitor as claimed in claim 1, wherein:
said outer casing has an inserting end and a docking end opposite to said inserting end and adjacent to said optical signal transmission device;
said outer casing is formed with an accommodating groove formed at said inserting end and extending toward said docking end; and
said optical signal monitoring device has a portion adapted to be inserted into the control system and received in said accommodating groove.

10. The pluggable optical channel monitor as claimed in claim 1, wherein:
said push-pull device includes
two locking resilient plates slidably connected to said outer casing and adapted for locking said outer casing to the control system, and
a push-pull handle connected to said locking resilient plates and operable to be pushed and pulled in order to lock and release said locking resilient plates to and from the control system.

11. The pluggable optical channel monitor as claimed in claim 10, wherein:
each of said locking resilient plates includes
a sliding plate body slidably connected to said outer casing and having a terminating end, and
an engaging plate body extending from said terminating end, being curved, and adapted for engaging the control system.

12. The pluggable optical channel monitor as claimed in claim 10, wherein:
said outer casing is formed with two limiting grooves;
said outer casing has two stop end surfaces each disposed at an end of a respective one of said limiting grooves; and
each of said locking resilient plates includes a protruding sheet body slidably received in a respective one of said limiting grooves and operable to abut against one of said stop end surfaces that is disposed at the end of said respective one of said limiting grooves to limit movement of said locking resilient plate relative to said outer casing when said push-pull handle is pulled.

13. The pluggable optical channel monitor as claimed in claim 10, wherein:
said push-pull device further includes two resilient members;
each of said resilient members is disposed between said outer casing and a respective one of said locking resilient plates and biases the respective one of said locking resilient plates in a direction opposite to said push-pull handle.
